(19) United States
(12) Patent Application Publication
(10) Pub. No.: US 2008/0181542 A1
(43) Pub. Date: Jul. 31, 2008

(54) METHOD FOR MANUFACTURING BEARING MEMBER

(75) Inventor: Masato GOMYO, Kyoto (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: NIDEC CORPORATION, Kyoto (JP)

(21) Appl. No.: 12/018,268

(22) Filed: Jan. 23, 2008

(30) Foreign Application Priority Data
Jan. 25, 2007 (JP) 2007-014491

(51) Int. Cl. F16C 32/06; B21D 53/10; B22F 3/24; H02K 7/08; G11B 3/70

(52) U.S. Cl. 384/100; 29/898.02; 419/28; 310/90; 369/272.1

(57) ABSTRACT

In a method for manufacturing a bearing member which is made of a porous material and has dynamic pressure grooves formed by electrochemical machining, the bearing member is impregnated with liquid such as hydrosoluble liquid or water prior to electrochemical machining. Since the hydrosoluble liquid or water is retained due to capillary force in the bearing member for which electrochemical machining is to be performed, the hydrosoluble liquid or water is not replaced with an electrolyte used in the electrochemical machining. Thus, the step of removing the electrolyte after electrochemical machining can be omitted, increasing production efficiency. Moreover, the bearing member is free from a trouble of rust as the electrolyte does not remain in the bearing member. Since the hydrosoluble liquid or water exhibits excellent affinity for the electrolyte, it does not harm processing accuracy in electrochemical machining and can be easily removed after electrochemical machining.

### BACKGROUND OF THE INVENTION

1. Field of the Invention

The present invention relates to a method for manufacturing a bearing member made of a porous material having a surface with dynamic pressure grooves formed thereon. The present invention also relates to a fluid dynamic bearing assembly, a spindle motor, and a disk drive respectively using the bearing member manufactured according to the method.

2. Description of the Related Art

There are some bearing assemblies each using a bearing member made of a porous material. In particular, an oil-retaining bearing member which is made of a porous sintered body impregnated with a lubricant is excellent in slidability since the lubricant is constantly supplied to a bearing surface. Specifically, such an oil-retaining bearing member hardly causes a lock phenomenon in which lubricity is deteriorated between the bearing member and a rotating member rotationally supported thereby and the rotating member becomes unrotatable. Thus, in recent years, the oil-retaining bearing member has been widely used as a bearing member in a rapidly rotating motor and the like.

Some fluid dynamic bearing assemblies employ the bearing members made of such porous sintered bodies. Such a bearing member is provided, on a bearing surface thereof, with dynamic pressure grooves for generating a dynamic pressure. Technique such as electrochemical machining is sometimes employed to form the dynamic pressure grooves on the bearing member in view of processing accuracy, processing rate, and the like. In order to apply such electrochemical machining, a bearing member made of metal is disposed to closely face an electrode tool which is provided with an exposed electrode portion having a pattern of dynamic pressure grooves to be formed on the bearing member. The bearing member and the electrode tool are electrically connected respectively to negative and positive terminals of an electrode processing power supply which is to be energized with a predetermined electrolyte flowing between the electrode tool and the bearing member. Accordingly, the bearing member is melted in correspondence with the pattern of the dynamic pressure grooves to be formed with dynamic pressure grooves.

When dynamic pressure grooves are formed on a porous sintered body by electrochemical machining as described above, an electrolyte such as a sodium nitrate solution intrudes into the porous sintered body. Although the intruded electrolyte can be washed away after the completion of electrochemical machining, such processing deteriorates production efficiency of the bearing member and it has been difficult to completely remove the electrolyte. If the electrolyte remains in the bearing member made of the porous sintered body, the remaining electrolyte corrodes the bearing member to generate rust, resulting in that duration of the bearing member is significantly decreased.

### SUMMARY OF THE INVENTION

According to a preferred embodiment of the present invention, there is provided a method for manufacturing a bearing member which is made of a porous material and has dynamic pressure grooves formed thereon by electrochemical machining. The bearing member which is to be subjected to electrochemical machining (hereinafter, referred to as an “intermediate member”) is impregnated with liquid such as hydrosoluble liquid or water, and then is subjected to electrochemical machining. The hydrosoluble liquid or water is not replaced with an electrolyte in the electrochemical machining, as the hydrosoluble liquid or water is retained in the intermediate member due to capillary force. That is, it is possible to prevent the electrolyte from intruding into the intermediate member. Accordingly, this manufacturing method does not require the step of removing the electrolyte after electrochemical machining, thereby improving production efficiency. Also, rust caused when the electrolyte remains in the bearing member can be prevented. Moreover, when the hydrosoluble liquid or water is used as the liquid with which the intermediate member is impregnated prior to electrochemical machining, processing accuracy in electrochemical machining is not harmed since the hydrosoluble liquid or water has excellent affinity for the electrolyte. In addition, the hydrosoluble liquid or water is easy to be removed after electrochemical machining.

According to another preferred embodiment of the present invention, there is provided a fluid dynamic bearing assembly using the bearing member which is manufactured in accordance with the above described method. Such a fluid dynamic bearing assembly requires less manufacturing cost since the bearing member is excellent in production efficiency. Further, the fluid dynamic bearing assembly may be used for a longer period of time since it can prevent various problems caused by a remaining electrolyte which has been used in electrochemical machining (such as the remaining electrolyte generating rust on dynamic pressure grooves formed on the bearing member to fail in generation of a predetermined dynamic pressure, a rusting component deteriorating lubricity, and the like).

According to still another preferred embodiment of the present invention, there are provided a spindle motor and a disk drive respectively including the above described fluid dynamic bearing assembly. The spindle motor and the disk drive can be manufactured at a reduced cost and be used for a longer period of time.

Other features, elements, advantages and characteristics of the present invention will become more apparent from the following detailed description of preferred embodiments thereof with reference to the attached drawings.

### BRIEF DESCRIPTION OF THE DRAWINGS

FIG. 1 is a flowchart of an exemplary method for manufacturing a bearing member according to a preferred embodiment of the present invention.

FIG. 2 is a flowchart of an exemplary method for impregnating an intermediate member with hydrosoluble liquid or water.

FIG. 3 is a flowchart of another exemplary method for impregnating the intermediate member with the hydrosoluble liquid or water.

FIG. 4 schematic shows an electrochemical machine.

FIG. 5 is a schematic view illustrating an example of covering an outer periphery of a sleeve with a container.

FIG. 6 is a cross sectional view of an exemplary fluid dynamic bearing assembly according to a preferred embodiment of the present invention.

FIG. 7 is a cross sectional view of an exemplary spindle motor according to a preferred embodiment of the present invention.

FIG. 8 shows an exemplary disk drive according to a preferred embodiment of the present invention.

### DETAILED DESCRIPTION OF PREFERRED EMBODIMENTS

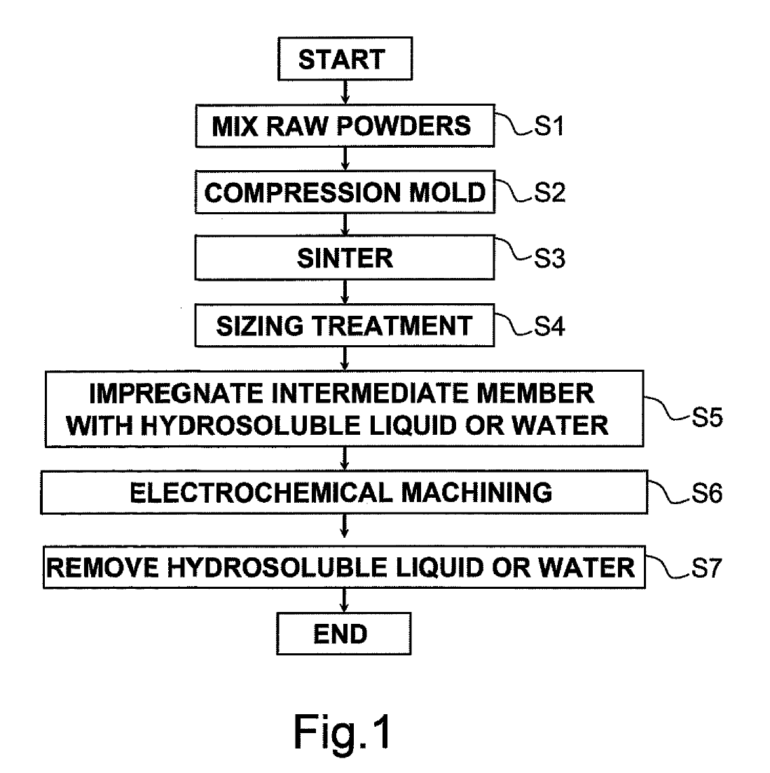

Referring to FIGS. 1 through 8, preferred embodiments of the present invention will be described in detail. It should be noted that in the explanation of the present invention, when positional relationships among and orientations of the different components are described as being up/down or left/right, ultimately positional relationships and orientations that are in the drawings are indicated; positional relationships among and orientations of the components once having been assembled into an actual device are not indicated. Meanwhile, in the following description, an axial direction indicates a direction parallel to a center axis of a motor, and a radial direction indicates a direction perpendicular to the center axis.

With regard to a method for manufacturing a bearing member used in a fluid dynamic bearing assembly, the bearing member being made of a porous material and having dynamic pressure grooves formed thereon by electrochemical machining, the inventor of the present application focused on prevention of an electrolyte from intruding into the bearing member which was to be subjected to electrochemical machining (hereinafter, referred to as an “intermediate member”). That is, the intermediate member corresponds to a member which is to be processed into the bearing member by electrochemical processing. The inventor has found out that liquid preliminarily impregnated in the intermediate member due to capillary force is not replaced with the electrolyte, resulting in that the electrolyte is prevented from intruding into the intermediate member. What the inventor has further found out is that, when hydrosoluble liquid or water is employed as the liquid to be impregnated in the intermediate member, the hydrosoluble liquid or water does not harm processing accuracy in electrochemical machining due to its excellent affinity for the electrolyte, and that the hydrosoluble liquid or water can be easily removed after the completion of electrochemical machining.

A feature of the manufacturing method according to a preferred embodiment of the present invention is that the intermediate member, which is a precursor of the bearing member, is impregnated with the hydrosoluble liquid or water, then dynamic pressure grooves are formed on a surface of the intermediate member by electrochemical machining, and thereafter, the hydrosoluble liquid or water impregnated in the intermediate member is removed therefrom so as to obtain a bearing member.

An example of the method for manufacturing a bearing member according to a preferred embodiment of the present invention is now described referring to the drawings. FIG. 1 is a flowchart of the method for manufacturing a bearing member made of a porous sintered body and to be used in a fluid dynamic bearing assembly.

First, raw powders are mixed together in accordance with a predetermined ratio to manufacture an intermediate member as a precursor of the bearing member, i.e., a member which will be processed into the bearing member (Step S1). Examples of the raw powders include carbides and alloys composed mostly of Fe, Ni, Cr, Co, Mo, Ti, or W. Among these, preferably used are alloys composed mostly of Fe. The alloys composed mostly of Fe may include alloys between Fe and one or more elements selected from a group of Al, Ti, Nb, Co, Cr, Mo, W, V, Ta, Si, C, B, Zr, and P.

The mixed raw powders are then formed into a predetermined shape. Such a predetermined shape is a shape of the bearing member, and may be a hollow cylindrical shape, a disk shape, a circular column shape, or an annular shape, for example. In this preferred embodiment, an upper mold provided with a salient is descended toward a lower mold, a cove of which is filled with the raw powders, so that the raw powders filled in the cove is compression molded, for example (Step S2). Although conditions for such compression molding are not specifically limited, it is preferable to perform compression molding with a molding pressure in a range of approximately 5 to approximately 8 ton/cm² for approximately 2 to approximately 10 seconds.

A compact obtained by compression molding is taken out of the both molds and sintered (Step S3). Then, sizing treatment is applied to the obtained porous sintered body so that the porous sintered body is accurately sized, thereby obtaining the intermediate member (Step S4). Although conditions for sintering are not specifically limited, preferred temperatures for sintering are in a range of approximately 980° C. to approximately 1180° C. for an iron based material, in a range of approximately 750° C. to approximately 900° C. for a copper based material, and in a range of approximately 1180° C. to approximately 1350° C. for stainless steel.

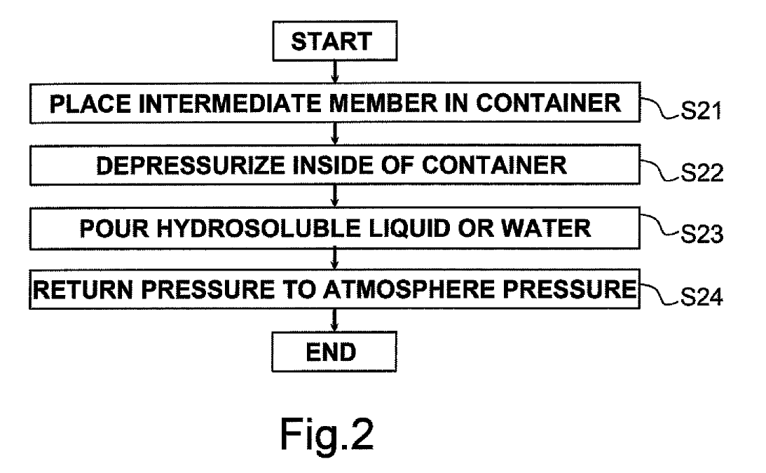

Thereafter, the intermediate member is impregnated with hydrosoluble liquid or water (Step 35). An exemplary method for impregnating the intermediate member with the hydrosoluble liquid or water is shown in FIG. 2. Referring to FIG. 2, the intermediate member is placed in a container (Step S21) and then the pressure inside the container is reduced (Step S22). The hydrosoluble liquid or water is poured into the container under the depressurized condition (Step S23). The thus poured hydrosoluble liquid or water is retained in the intermediate member made of the porous material. Then, the pressure in the container is returned to the atmospheric pressure (Step S24), so that the hydrosoluble liquid or water retained in the intermediate member is impregnated further inwards.

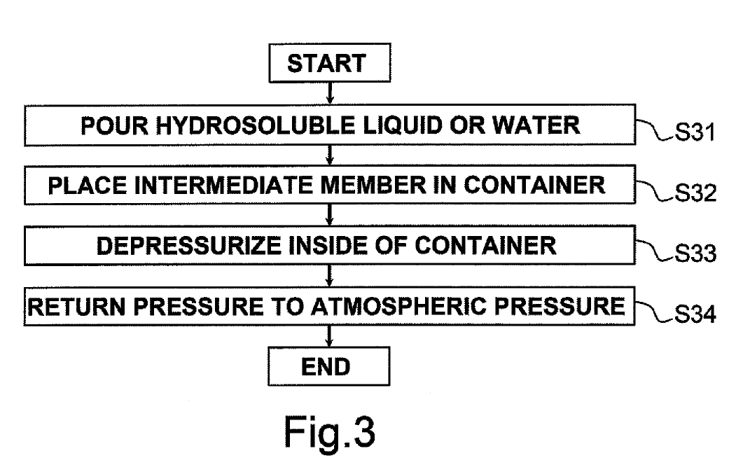

Alternatively, another exemplary method shown in the flowchart of FIG. 3 may be used. In accordance with this method, the intermediate member is placed in a container having therein the hydrosoluble liquid or water so as to bring outer surfaces of the intermediate member partially or entirely into contact with the hydrosoluble liquid or water. When the inside of the container is depressurized under such a condition, the hydrosoluble liquid or water is impregnated in the intermediate member. Then, the pressure in the container is returned to that of the atmospheric pressure, so that the hydrosoluble liquid or water retained in the intermediate member is impregnated further inwards. In this method, the intermediate member may be placed in the container at the same time as the hydrosoluble liquid or water is poured into the container. Alternatively, the hydrosoluble liquid or water may be poured into the container after the intermediate member is placed therein. Further, the inside of the container may be depressurized at the same time as the intermediate member is brought into contact with the hydrosoluble liquid or water.

There are still other methods such as impregnating the intermediate member with pressurized hydrosoluble liquid or water, bringing the outer surfaces of the intermediate member into contact with the hydrosoluble liquid or water while the intermediate member is being held with a jig so as to impregnate the intermediate member with the hydrosoluble liquid or water. It is noted that, in the lastly illustrated method, the hydrosoluble liquid or water to be impregnated needs to be applied with a pressure larger the atmospheric pressure.

The hydrosoluble liquid used in the respective methods described above is preferable to be excellent in affinity for the electrolyte, such as methanol or ethanol, which is alcohol having at most four carbons. Purified water, highly purified water, distilled water may be employed as the water used in the respective methods described above.

Returning to FIG. 1, after the intermediate member is impregnated with the hydrosoluble liquid or water, performed is the step of forming dynamic pressure grooves by electrochemical machining on a predetermined outer surface of the intermediate member (Step S6). More specifically, the intermediate member impregnated with the hydrosoluble liquid or water is placed in an electrochemical machine. At this stage, the hydrosoluble liquid or water is retained in the intermediate member due to capillary force within numerous pores in the intermediate member.

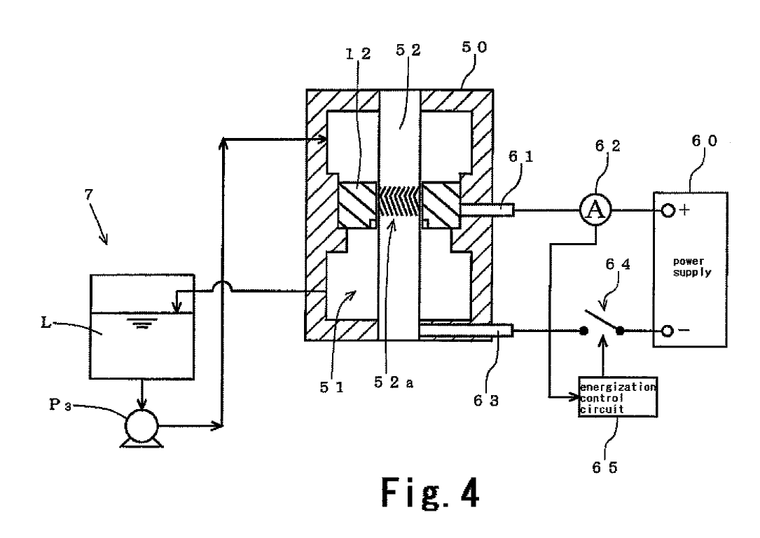

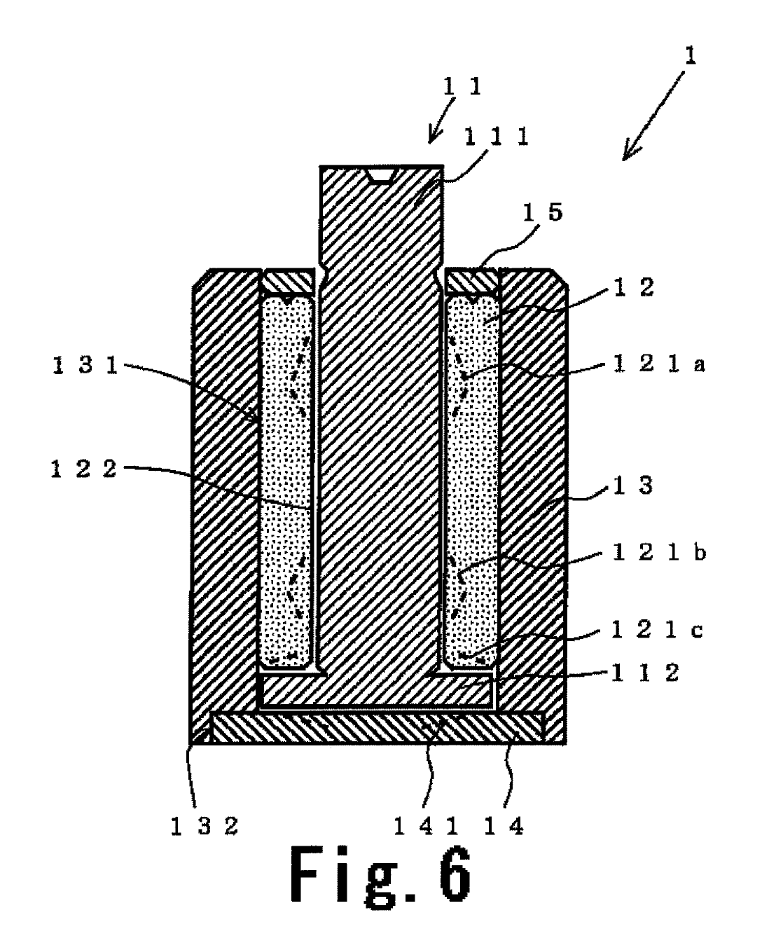

FIG. 4 shows a general configuration of the electrochemical machine used in the electrochemical machining. As shown in FIG. 4, in the electrochemical machine, a tool electrode 52 is attached to a working machine housing 50 which forms a work bowl 51. An intermediate member 12 to be processed is disposed in the work bowl 51 such that a portion to be processed faces the tool electrode 52. The intermediate member 12 has a hollow cylindrical shape. As an example of the hollow cylindrical member, there is shown a sleeve 12 (to be described later with reference to FIG. 6) with dynamic pressure grooves in a herringbone shape formed on an inner peripheral surface thereof. In this case, the tool electrode 52 has a column shape. The sleeve 12 and the tool electrode 52 are attached to the working machine housing 50 such that an exposed electrode 52a of the tool electrode 52 faces the inner peripheral surface of the sleeve 12 with a minute space therebetween. The exposed electrode 52a is formed in a shape similar to a groove pattern of the dynamic pressure grooves to be formed on the sleeve 12, so as to have a width slightly smaller than that of the dynamic pressure grooves on the processed sleeve 12.

The sleeve 12 is electrically connected to a positive terminal 61 extending from a positive power terminal of a processing power supply 60. There is provided between the sleeve 12 and the positive terminal 61 a current sensor 62 for sensing a current flowing therebetween. On the other hand, the tool electrode 52 is electrically connected to a negative terminal 63 extending from a negative power terminal of the processing power supply 60. Provided between the tool electrode 52 and the processing power supply 60 is a switcher 64 for switching on/off a direct current voltage (pulse voltage) supplied from the processing power supply 60. There is provided between the switcher 64 and the current sensor 62 an energization control circuit 65 for controlling switching of the switcher 64.

Further, there is provided outside the work bowl 51 a storage tank 7 containing an electrolyte L. The storage tank 7 is connected to the work bowl 51 by a supply pipe for supplying the electrolyte L into the work bowl 51 and a discharge pipe for with drawing the electrolyte L from the work bowl 51. There is provided a pump P₃ on the supply pipe. During electrochemical machining, the electrolyte L supplied into the work bowl 51 flows from an upper portion of the work bowl 51 through the minute space between the sleeve 12 and the tool electrode 52 to reach a lower portion of the work bowl 51. The electrolyte L is then withdrawn from the lower portion of the work bowl 51 through the discharge pipe into the storage tank 7, and is supplied again into the work bowl 51 by the pump P₃. Thus, the electrolyte L is repeatedly circulated.

When the electrolyte L flows through the minute space between the sleeve 12 and the tool electrode 52, the inner peripheral surface of the sleeve 12 facing the exposed electrode 52a is melted in correspondence with the shape of the exposed electrode 52a due to an electrochemical action. A product obtained by the melted sleeve 12 is mixed into the electrolyte L. In this state, the electrolyte L is in contact with outer peripheral surfaces of the sleeve 12. However, the electrolyte L hardly intrudes into the sleeve 12 since the sleeve 12 is impregnated with the hydrosoluble liquid or water. Accordingly, in the electrochemical machining performed in this preferred embodiment, although the member to be processed is made of a porous material, the member can be processed without allowing the electrolyte to intrude into the porous material.

Since electrochemical machining generally has an extremely large current density and an extremely small processing space, processing accuracy is influenced largely by an electrochemical product thereof and the temperature of the electrolyte. Thus, a flow rate of the electrolyte is required to be large in the work bowl 51 during electrochemical machining. It is desirable to set the flow rate to be in a range of approximately 6 to approximately 60 m/sec.

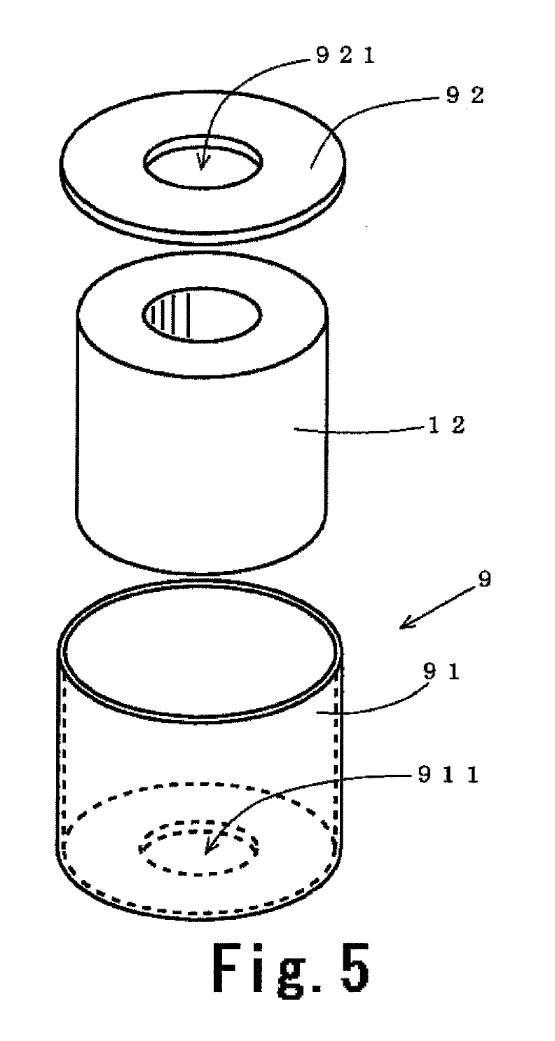

When the rapidly circulating electrolyte L hits the outer peripheral surface of the sleeve 12, the hydrosoluble liquid or water retained in the sleeve 12 may leak out of the sleeve 12. In order to prevent such leaking, as shown in FIG. 5, electrochemical machining may be applied to the sleeve 12 with a container 9 covering the outer surfaces of the sleeve 12. More specifically, the container 9 includes a container main body 91 having a substantially cylindrical shape with a bottom and an inner diameter identical to or slightly larger than an outer diameter of the sleeve 12, and a lid member 92 for closing an upper opening of the container main body 91. In the bottom of the container main body 91 and the lid member 92 are respectively formed a through hole 911 and a through hole 921 having approximately the same diameter as that of a through hole 122 of the sleeve 12. The through holes 911 and 912 are concentric with the through hole 122 of the sleeve 12. The tool electrode 52 is inserted into the through holes 911 and 921 during electrochemical machining. The outer periphery of the sleeve 12 is covered with the container 9 as described above so as to prevent the electrolyte L from hitting hard the sleeve 12, thereby suppressing leak of the hydrosoluble liquid or water out of the sleeve 12. It is noted that the container 9 shown in FIG. 5 is merely one example thereof and the configuration of the container 9 is not limited thereto.

In a case where the electrochemical product is precipitable, such an electrochemical product is preferably separated and removed from the electrolyte L in the storage tank 7 by centrifugation, sedimentation, filtration, or any combination thereof, so that the purified electrolyte L is circulated.

During electrochemical machining, when the switcher 64 is switched on for a predetermined period of time (processing period of time), a direct current voltage (pulse voltage) is applied across the sleeve 12 and the tool electrode 52, and a current supplied from the processing power supply 60 flows between the sleeve 12 and the tool electrode 52. The current flowing between the sleeve 12 and the tool electrode 52 is sensed by the current sensor 62. The sensed result is sent from the current sensor 62 to the energization control circuit 65. The energization control circuit 65 controls switching on/off of the switcher 64 in accordance with a sensed value thereof. Accordingly, a surface material of the sleeve 12 facing the exposed electrode 52a of the tool electrode 52 is melted into the electrolyte L, so that the surface of the sleeve 12 is processed to have a shape (dynamic pressure grooves) corresponding to the pattern of the exposed electrode 52a. In this manner, dynamic pressure grooves are formed on the surface of the sleeve 12.

Processing conditions for electrochemical machining may be appropriately determined in accordance with the composition and shape of the bearing member, the depth, width and shape of the grooves to be formed, and the like. According to one example of the processing conditions, when a processing voltage is set to 10 V and a processing current is set to 10 A with a processing period of time (period of time for the switcher 64 being switched on) of three seconds, while setting to 0.1 mm the space between the surface to be processed of the sleeve 12 and the electrode surface of the tool electrode 52, there are formed dynamic pressure grooves in a desired shape with a depth of approximately 10 μm.

In general, the sleeve 12 preferably has a surface porosity of approximately 15% or less, and more preferably in a range of approximately 5 to approximately 10% in view of flowage of a lubricant. Further, the portion with the dynamic pressure grooves formed thereon preferably has a surface porosity of approximately 5% or less as such a portion is required to flow the lubricant so that a dynamic pressure is generated. In order to partially decrease the surface porosity, some processing may be performed such as sealing treatment. It is noted that the above described surface porosity refers to a ratio of an opened area per unit area.

Returning to FIG. 1, the hydrosoluble liquid or water is removed from the intermediate member 12, i.e., the sleeve 12 (Step S7) on which the dynamic pressure grooves have been formed. In order to remove the hydrosoluble liquid or water, it is possible to employ methods such as heating the intermediate member 12 to evaporate moisture, placing the intermediate member under a depressurized condition to extract moisture and dry the intermediate member by utilizing difference in pressure, scattering moisture by utilizing centrifugal force, or sucking moisture by using a high-pressure suction device. The hydrosoluble liquid or water is thus removed from the intermediate member 12, thereby obtaining a bearing member. The bearing member may be further subjected to surface treatment, finish processing, and the like in accordance with application and performance of the bearing member.

As described above, in the method for manufacturing the bearing member in this preferred embodiment, the dynamic pressure grooves can be formed by electrochemical machining even on the bearing member made of the porous material without allowing the electrolyte to intrude into the bearing member. Accordingly, there is little electrolyte remaining in the obtained bearing member. Further, the hydrosoluble liquid or water, which has been impregnated in the intermediate member prior to electrochemical machining, does not harm processing accuracy in electrochemical machining due to its excellent affinity for the electrolyte. Since the hydrosoluble liquid or water can be removed relatively easily, the hydrosoluble liquid or water by itself does not cause a trouble such as generation of rust. In a case where the porous material is sintered, for example, it is possible to heat the sleeve 12 in order to remove the hydrosoluble liquid or water without harming the sleeve 12, since the porous sintered body is excellent in thermal resistance.

Referring to FIG. 6, there is described a dynamic bearing assembly using the bearing member manufactured in accordance with the above described method. The bearing member in this case corresponds to the above described sleeve 12 made of the porous sintered body. The sleeve 12 is provided with two radial dynamic pressure grooves 121a and 121b respectively on axial upper and lower regions of the inner peripheral surface thereof. Further, the sleeve 12 is provided with thrust dynamic pressure grooves 121c on a lower end surface thereof. In the above described manufacturing method, there is exemplified a configuration in which the dynamic pressure grooves are formed only on the inner peripheral surface of the sleeve 12. The thrust dynamic pressure grooves 121c may also be formed according to the same manufacturing method. In such a case, the radial dynamic pressure grooves 121a and 121b and the thrust dynamic pressure grooves 121c may be formed separately or simultaneously.

In a dynamic bearing assembly 1 shown in FIG. 6, the sleeve 12 is fixed onto an inner peripheral surface of a housing 13 which is hollow and cylindrical. A through hole 131 is formed in the housing 13 so as to axially penetrate through the housing 13 and is closed at a lower end thereof by a thrust bush 14. Thus, the housing 13 and the thrust bush 14 form a cylindrical shape with a bottom, that is, an approximately cup shape. The thrust bush 14 has a disk shape having an upper surface with approximately annular shaped dynamic pressure grooves 141 formed thereon, and is fixed to a fitting groove portion 132 of the housing 13.

In the dynamic bearing assembly 1, a shaft member 11 is disposed in a rotatable manner relative to the housing 13 and the like, and includes a shaft portion 111 and a thrust plate portion 112 (corresponding to a flange portion) formed at a lower and of the shaft portion 111. The shaft portion 111 is inserted into the through hole 122 of the sleeve 12. Accordingly, an outer peripheral surface of the shaft portion 111 faces the inner peripheral surface of the sleeve 12 with a first minute gap g1 therebetween, an upper surface of the thrust plate portion 112 faces a lower end surface of the sleeve 12 with a second minute gap g2 therebetween, a bottom surface of the thrust plate portion 112 faces a top surface of the thrust bush 14 with a third minute gap g3 therebetween, and an outer peripheral surface of the thrust plate portion 112 faces an inner peripheral surface of the housing 13 with a fourth minute gap g4 therebetween. An upper end surface of the sleeve 12 is located below an upper end surface of the housing 13. To the upper end surface of the sleeve 12 is fixed a sealing member 15. The sealing member 15 is in an annular shape in this preferred embodiment. The sealing member 15 has an outer diameter approximately the same as the inner diameter of the sleeve 12, and is fixed directly to the housing 13 with substantially no space therebetween.

Some of the lubricant (not shown) is retained in the above described first, second, third, and fourth minute gaps g1, g2, g3, and g4, while the other is retained in the sleeve 12. The lubricant continuously exists with substantially no bubbles included therein, and circulates among the inside of the sleeve 12 and the respective minute gaps g1, g2, g3, and g4. In a tapered seal portion g5 provided between an inner peripheral surface of the sealing member 15 and the outer peripheral surface of the shaft portion 111, an interface is formed between the lubricant and air. The lubricant is retained so as not to leak outside by capillary force acting in the tapered seal portion g5.

In the dynamic bearing assembly 1 of this preferred embodiment, when the shaft member 11 rapidly rotates, the lubricant is pressurized by the respective dynamic pressure grooves 121a, 121b, 121c, and 141, thereby fluid dynamic pressures are generated in the respective minute gaps g1, g2, g3, and g4. More specifically, the dynamic pressures generated by the dynamic pressure grooves 121a and 121b support a radial load applied to the shaft member 11, i.e., a load applied in a radial direction perpendicular to or substantially perpendicular to the axial direction. On the other hand, the dynamic pressures generated by the dynamic pressure grooves 121c and 141 support an axial load or a thrust load applied to the shaft member 11.

In the dynamic bearing assembly 1 of this preferred embodiment, the lubricant can be retained in the sleeve 12 as the sleeve 12 is made of a porous material. Thus, a larger amount of the lubricant may be retained in the bearing assembly, so that the bearing assembly can accordingly be used for a longer period of time. Moreover, since the lubricant is constantly supplied from the surfaces of the sleeve 12 facing the respective minute gaps g1, g2, and g3, slidability is improved with respect to the shaft member 11, thereby causing less troubles such as a lock phenomenon.

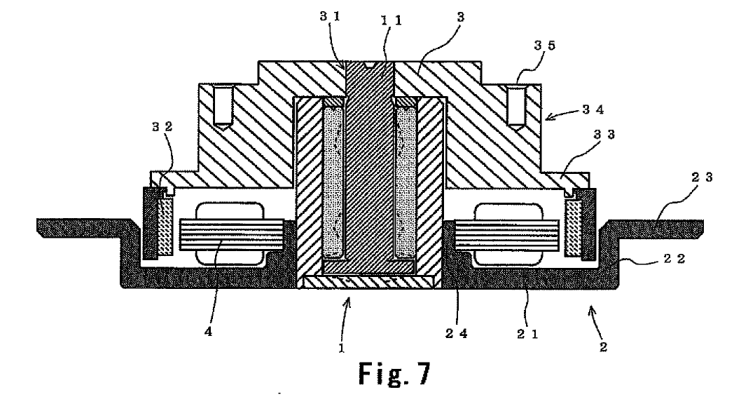

Referring to FIG. 7, described below is a spindle motor according to a preferred embodiment of the present invention. This spindle motor is characterized by the above described fluid dynamic bearing assembly 1. FIG. 7 is a cross sectional view of a spindle motor 10 for a hard disk drive (hereinafter, referred to as an “HDD”) which includes the fluid dynamic bearing assembly 1, as an example of the spindle motor, cut along a plane containing its rotation axis. In the spindle motor 10, the fluid dynamic bearing assembly 1 is fitted and fixed to a bearing support portion 24 having a substantially cylindrical shape. The fluid dynamic bearing assembly 1 is provided at a center of a bracket 2. A stator 4 is fixed to an outer peripheral surface of the bearing support portion 24. A rotor hub 3 in an approximately cylindrical shape is fixed to an upper end of the shaft member 11 in the fluid dynamic bearing assembly 1. To an inner peripheral surface of the rotor hub 3 is fixed a rotor magnet 32 which has a substantially annular shape and faces an outer peripheral surface of the stator 4 with a space therebetween. There is mounted a disk (not shown) for storing information therein, on a flat surface 33 of the rotor hub 3 which extends radially outwards into an annular shape.

Since the spindle motor 10 includes the above described fluid dynamic bearing assembly 1, the spindle motor 10 can be used for a long period of time and be highly reliable with a less possibility of troubles such as a lock phenomenon. It is noted that, in the spindle motor 10, the bracket 2 and the stator 4 correspond to a stationary assembly while the rotor hub 3 and the rotor magnet 32 correspond to a rotor assembly.

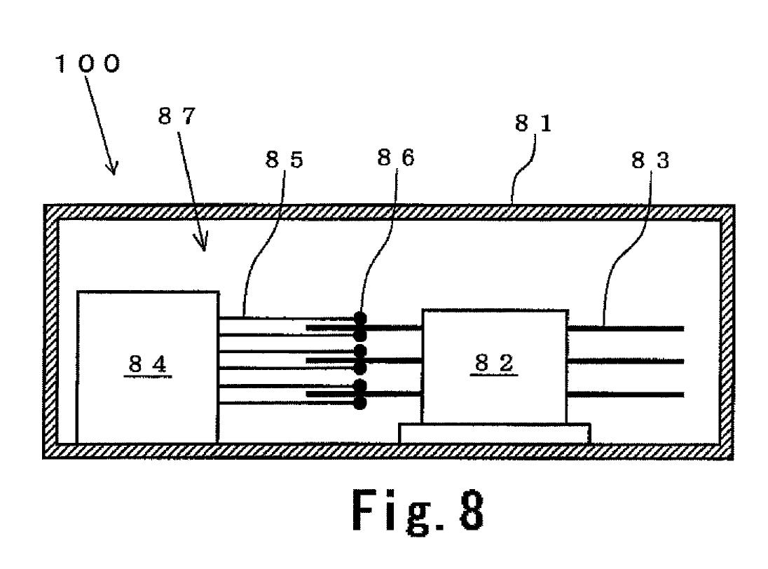

Referring to FIG. 8, described below is a disk drive according to a preferred embodiment of the present invention. This disk drive is characterized by a spindle motor 82 of a configuration similar to the spindle motor of FIG. 7. FIG. 8 shows an HDD 100 including the spindle motor 82 as an example of the disk drive. In the HDD 100, an outer frame 81, which forms therein a clean space, accommodates the spindle motor 82 with disks 83 respectively storing information and mounted thereon, and an accessing unit 87 capable of performing at least one of writing information on and reading information from the disks 83. The accessing unit 87 includes heads 86 arranged at its distal end, arms 85 for respectively supporting the heads 86, and an actuator 84 for moving the heads 86 to desired positions on the disks 83. Though not shown, as another example of the disk drive, there is one using removable disks.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

Although the sleeve 12 is exemplified as the bearing member in the above described method for manufacturing a bearing member, the manufacturing method may be applied to a case where the thrust bush 14 is made of a porous material and the dynamic pressure grooves 141 are formed on the thrust bush 14 by electrochemical machining. The shaft member 11 may include the shaft portion 111 and the thrust plate portion 112 which are formed separately from each other. The respective dynamic pressure grooves 121a, 121b, 121c, and 141 may be alternatively provided to the shaft portion 111 on the surfaces respectively facing the sleeve. In such a case, the above described method for manufacturing a bearing member may be applied when the shaft member 11 is made of a porous material and the respective dynamic pressure grooves are formed thereon by electrochemical machining.

Although the porous sintered body is exemplified as the above described sleeve 12, the sleeve 12 may be a porous sintered body formed in accordance with another technique. Moreover, although the fluid dynamic bearing assembly 1 described above is of a type in which the thrust dynamic pressure grooves 121c are provided on an axially lower side in FIG. 6, the fluid dynamic bearing assembly 1 may be of a different type in which the thrust dynamic pressure grooves 121c are provided on an axially upper side. Although the shaft member 11 is rotated in the above described preferred embodiment, the sleeve may be alternatively rotated. The housing 13 and the thrust bush 14 may be formed together as a single member, while the housing 13 and the sealing member 15 may be formed together as a single member so as to form a cup shape with an opening at a lower side thereof.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A method for manufacturing a bearing member for use in a fluid dynamic bearing assembly, the bearing member being made of a porous material and having grooves formed thereon for generating a fluid dynamic pressure, the method comprising:
a) preparing an intermediate member made of the porous material which is to be processed into the bearing member;
b) impregnating the intermediate member with hydrosoluble liquid or water;
c) forming the grooves on a surface of the intermediate member by electrochemical machining after b); and
d) removing the hydrosoluble liquid or water from the intermediate member to obtain the bearing member.

2. The method according to claim 1, wherein b) includes:
bringing the hydrosoluble liquid or water into contact with the surface of the intermediate member placed under a reduced pressure; and
then placing the intermediate member under a pressure higher than the reduced pressure.

3. The method according to claim 1, wherein b) includes:
bringing the hydrosoluble liquid or water into contact with the surface of the intermediate member;
simultaneously with or after the bringing of the hydrosoluble liquid or water, reducing a pressure under which the intermediate member is placed to impregnate the intermediate member with the hydrosoluble liquid or water; and
after the reducing of the pressure, placing the intermediate member under a pressure higher than the reduced pressure.

4. The method according to claim 1, wherein the hydrosoluble liquid is alcohol having four carbons or less per molecule.

5. The method according to claim 1, wherein the intermediate member is hollow and substantially cylindrical about a center axis, and
the grooves are formed on an inner peripheral surface of the intermediate member by electrochemical machining in c).

6. The method according to claim 5, wherein the grooves are formed on the inner peripheral surface and an axial end surface of the intermediate member at the same time by electrochemical machining in c).

7. The method according to claim 1, wherein the intermediate member is in the form of a circular column centered on a center axis, and
the grooves are formed on an outer peripheral surface of the intermediate member.

8. The method according to claim 7, wherein the intermediate member in the form of a circular column is provided with a flange portion at its axial end, the flange portion extending away from the center axis in a radial direction substantially perpendicular to the center axis, and
the grooves are formed on the outer peripheral surface of the intermediate member and on an axial end surface of the flange portion at the same time by electrochemical machining in c).

9. The method according to claim 1, wherein the hydrosoluble liquid or water is removed by heating the intermediate member in d).

10. The method according to claim 1, further comprising
e) compression-molding raw material powders of the bearing member and then sintering the compression-molded powders, prior to b).

11. A fluid dynamic bearing assembly comprising:
an approximately cup-shaped housing having an opening end and a closing end opposite to the opening end;
a hollow, substantially cylindrical sleeve arranged in the housing; and
a shaft member inserted into the sleeve with a gap arranged therebetween, wherein
at least one of the sleeve and the shaft member is the bearing member manufactured by the method according to claim 1.

12. A spindle motor comprising:
the fluid dynamic bearing assembly according to claim 11;
a rotor assembly supported by the fluid dynamic bearing assembly in a rotatable manner; and
a stationary assembly supporting the fluid dynamic bearing assembly.

13. A disk drive for use with a disk-shaped storage medium capable of storing information therein, comprising:
the spindle motor according to claim 12 arranged to rotate the storage medium;
an accessing unit arranged to carry out at least one of writing information on and reading information from the storage medium; and
an outer frame accommodating the spindle motor and the accessing unit.
